(19) United States
(12) Patent Application Publication
(10) Pub. No.: US 2026/0269731 A1
(43) Pub. Date: Sep. 10, 2026

(54) SWITCHING TRANSFORMER, SWITCHING POWER SUPPLY DEVICE COMPRISING SAME, IN-VEHICLE ELECTRIC COMPRESSOR COMPRISING SAME, AND METHOD FOR MANUFACTURING SWITCHING TRANSFORMER

(71) Applicant: SANDEN CORPORATION, Gunma (JP)

(72) Inventors: Kohei TAKADA, Gunma (JP); Koji KOBAYASHI, Gunma (JP)

(73) Assignee: SANDEN CORPORATION, Gunma (JP)

(21) Appl. No.: 19/165,273

(22) PCT Filed: Jul. 16, 2024
(86) PCT No.: PCT/JP2024/025412

§ 371 Date: Sep. 15, 2025

(30) Foreign Application Priority Data
Aug. 10, 2023 (JP) 2023-131114

(51) Int. Cl. H02M 3/335; B60R 16/03; H01F 27/24; H01F 27/28; H01F 27/32

(52) U.S. Cl. CPC H02M 3/335; B60R 16/03; H01F 27/24; H01F 27/2823; H01F 27/325

(57) ABSTRACT

There is provided a switching transformer capable of reducing only parasitic capacitance and reducing noise while maintaining the magnetic coupling of winding wires of the switching transformer. A switching transformer 15 includes a primary winding wire 13 on a low-voltage side, a secondary winding wire 14 on a high-voltage side, a bobbin 43 having a winding shaft portion 61 at the center around which the primary winding wire and the secondary winding wire are wound and a flange portion 62, and the core 46 having a middle leg portion 67 inserted into a through hole of the winding shaft portion 61 to insulate the low-voltage side from the high-voltage side. An air gap layer G is formed between the winding shaft portion 61 and the middle leg portion 67.

### TECHNICAL FIELD

The present invention relates to a switching transformer that insulates a low-voltage side from a high-voltage side, a switching power supply device equipped with the switching transformer, an in-vehicle electric compressor equipped with the switching power supply device, and a method of manufacturing the switching transformer.

### BACKGROUND ART

Hybrid vehicles and electric vehicles have been developed in response to the recent manifestation of global environmental problems. In an air conditioner that air-conditions the interior of a vehicle, an electric compressor including a motor is used instead of an engine-driven compressor. In this case, a vehicle is mounted with a high-voltage power supply including a high-voltage battery of, e.g., about a direct current of 300 V (300 V DC) and a low-voltage power supply including a standard battery of a direct current of 12 V (12 V DC), and a motor of an electric compressor is supplied with a voltage obtained by converting the direct voltage of the high-voltage power supply into an alternating current by an inverter circuit.

On the other hand, the DC voltage of the low-voltage power supply is converted into a predetermined voltage (e.g., 15 V DC or the like) by the switching power supply device and supplied to a control circuit that controls the inverter circuit. Therefore, the switching power supply device is provided with a switching transformer including an isolation transformer, and the primary side of the switching transformer, i.e., the low-voltage side connected to the low-voltage power supply, and the secondary side, i.e., the high-voltage side connected to the high-voltage power supply, are isolated from each other.

In addition, regarding noise reduction measures, the primary side (low-voltage side) and the secondary side (high-voltage side) of the switching transformer are grounded to a chassis (chassis GND: ground) of the electric compressor via a Y capacitor (line bypass capacitor), and an EMI filter circuit is further provided between the low-voltage power supply and the switching power supply device.

Here, as measures against EMI noise caused by the switching power supply device, there has been a structure in which a primary-side ground and a secondary-side ground insulated by a switching transformer are connected by a reflux capacitor. According to such a structure, it can be expected to reduce the noise voltage by returning the noise mutually transmitted between a primary winding wire and a secondary winding wire via a parasitic capacitance (coupling capacitance) between the winding wires of the switching transformer and suppressing a common mode noise current flowing to the ground (chassis of the electric compressor) side (see, e.g., Patent Literature 1).

In addition, the structure of the switching transformer often adopts a sandwich winding structure in which the secondary winding wire is sandwiched between the primary winding wires in order to improve the degree of coupling of the primary winding wire to the secondary winding wire. However, improving the magnetic coupling using such a structure is synonymous with increasing the facing area between the primary winding wire and the secondary winding wire. As a result, the parasitic capacitance generated between the primary winding wire and the secondary winding wire increases, and the common mode noise increases.

Therefore, there has been a technique of separating the primary winding wire from the secondary winding wire of the switching transformer to reduce the facing area between the primary winding wire and the secondary winding wire, and thus, the magnetic coupling of the primary winding wire to the secondary winding wire is reduced, and the parasitic capacitance between the winding wires is reduced. There has been an effect of reducing the amount of noise converted into the common mode using such a structure (see, e.g., Patent Literature 2).

### CITATION LIST

### Patent Literature

Patent Literature 1: Japanese U.S. Pat. No. 7,009,325
Patent Literature 2: JP-A-2021-2913

### SUMMARY OF INVENTION

### Problems to be Solved by Invention

Generally, in a switching transformer, the magnetic coupling of a primary winding wire to a secondary winding wire and the parasitic capacitance between the primary winding wire and the secondary winding wire are in a trade-off relationship, and it is difficult to reduce the parasitic capacitance while strengthening the magnetic coupling. However, since the parasitic capacitance between the primary winding wire and the secondary winding wire becomes a cause of the generation of a common mode current (common mode noise), it is necessary to reduce the parasitic capacitance.

In Patent Literature 2, in order to reduce the common mode noise, the degree of coupling between the primary winding wire and the secondary winding wire is reduced to reduce the parasitic capacitance between the winding wires and reduce the common mode current. However, in such a structure, the magnetic coupling between the winding wires is poor, and it becomes difficult to secure the voltage regulation originally necessary as a power supply device, and thus, there is a disadvantage that the structure is not suitable to a feedback-free power supply (power supply that does not control the switching on the primary side by the voltage on the secondary side).

Here, regarding the reduction of the EMI noise caused by the switching power supply noise, it has been confirmed that not only the parasitic capacitance between the primary winding wire and the secondary winding wire but also the parasitic capacitance between the winding wires passing through the core of the switching transformer exerts an influence in the high frequency band, which causes the degradation in the noise.

The present invention has been made to solve the background-art technical problems, and an object of the present invention is to provide a switching transformer capable of reducing only parasitic capacitance and reducing noise while maintaining magnetic coupling between winding wires of the switching transformer, a switching power supply device equipped with the switching transformer, an in-vehicle electric compressor equipped with the switching power supply device, and a method of manufacturing the switching transformer.

### Solution to Problems

A switching transformer of the present invention includes a primary winding wire and a secondary winding wire to insulate a low-voltage side from a high-voltage side, the switching transformer including: a bobbin having a winding shaft portion at a center around which the primary winding wire and the secondary winding wire are wound and flange portions respectively formed on both sides of the winding shaft portion in an axial direction; and a core having a middle leg portion to be inserted into a through hole of the winding shaft portion, in which an air gap layer or a shield layer is formed between the winding shaft portion and the middle leg portion.

In the switching transformer according to the invention of claim 2, a recess is formed on an inner surface of the winding shaft portion or an outer surface of the middle leg portion to form an air gap layer in the above-described invention.

In the switching transformer according to the invention of claim 3, the core includes an outer leg portion that covers an outer side of the bobbin, and the outer leg portion includes an overhanging portion that overhangs in a direction away from the middle leg portion, in the invention according to claim 1.

In the switching transformer according to the invention of claim 4, a dimension between the inner surface of the overhanging portion and the primary winding wire or the secondary winding wire of the outermost layer is equal to or substantially equal to a dimension in a direction orthogonal to the air gap layer or the middle leg portion of the shield layer in the invention, in the above-described invention,.

In a switching power supply device according to the invention of claim 5, a low-voltage side is connected to a low-voltage power supply, a high-voltage side is connected to a high-voltage power supply, the primary winding wire of the switching transformer according to the above-described inventions is on the low-voltage side, the secondary winding wire is on the high-voltage side, and the low-voltage power supply is switched to supply power to a control circuit located on the high-voltage side.

An in-vehicle electric compressor according to the invention of claim 6 includes: the switching power supply device according to the above-described invention that switches a low-voltage power supply mounted on a vehicle; a control circuit; an inverter circuit that is supplied with power from a high-voltage power supply mounted on the vehicle and controlled by the control circuit; and a motor driven by the inverter circuit.

A method of manufacturing a switching transformer according to the invention of claim 7, in which when an insulated wire is used as the primary winding wire and the secondary winding wire, a barrier tape provided between the primary winding wire and the secondary winding wire and a flange portion of a bobbin is not used, and a width dimension of the flange portion is increased within a range of a width dimension of the barrier tape, in the invention according to claims 1 to 4.

In the method of manufacturing a switching transformer according to the invention of claim 8, an enlarged width of the width dimension of the flange portion is equal to or substantially equal to a dimension in a direction orthogonal to the middle leg portion of the air gap layer or the shield layer, in the above-described invention.

### Effects of Invention

The parasitic capacitance between the primary winding wire and the secondary winding wire of the switching transformer includes a parasitic capacitance due to a physical distance between the winding wires and a parasitic capacitance via a core (material ferrite: Mn—Zn or the like).

Therefore, according to the present invention, the switching transformer includes the primary winding wire and the secondary winding wire to insulate the low-voltage side from the high-voltage side, the switching transformer including: the bobbin having the winding shaft portion at the center around which the primary winding wire and the secondary winding wire are wound and the flange portions respectively formed on both sides of the winding shaft portion in the axial direction; and the core having the middle leg portion to be inserted into the through hole of the winding shaft portion, in which the air gap layer or the shield layer is formed between the winding shaft portion and the middle leg portion. Therefore, the distance between the primary winding wire or the secondary winding wire of the innermost layer closest to the core and the middle leg portion of the core is secured by the air gap layer or the shield layer, and, It becomes possible to improve the coupling between the primary winding wire and the secondary winding wire via the core.

That is, it is possible to reduce the parasitic capacitance between the primary winding wire and the secondary winding wire via the core, and it is possible to reduce the amount of noise converted into the common mode, consequently, while maintaining the magnetic coupling between the winding wires.

At this time, there is a concern about an increase in leakage magnetic flux by providing an air gap layer or the like, but the relative permeability of the core is sufficiently large, and the influence of the increase in leakage magnetic flux is limited due to the structure of the switching transformer.

Note that, actually, as in the invention of claim 2, the recess is formed on the inner surface of the winding shaft portion or the outer surface of the middle leg portion to form the air gap layer. Note that the air gap layer formed of the recess can also be used in the case of forming the shield layer.

In addition, as in the invention of claim 3, when the overhanging portion that overhangs in the direction away from the middle leg portion is provided on the outer leg portion of the core that covers the outer side of the bobbin, it is possible to avoid the disadvantage that the distance between the one winding wire or the secondary winding wire of the outermost layer and the outer leg portion of the core becomes short by providing the air gap layer or the like between the winding shaft portion and the middle leg portion. As a result, it is also possible to eliminate an increase in the parasitic capacitance between the primary winding wire and the secondary winding wire via the outer leg portion of the core.

In this case, as in the invention of claim 4, by making the dimension between the inner surface of the overhanging portion and the primary winding wire or the secondary winding wire of the outermost layer equal to or substantially equal to the dimension in the direction orthogonal to the air gap layer or the middle leg portion of the shield layer, it is possible to prevent unnecessary external size expansion of the switching transformer.

As in the invention of claim 5, the switching transformer of the above inventions is suitable for a switching power supply device in which the low-voltage side is connected to the low-voltage power supply, the high-voltage side is connected to the high-voltage power supply, the primary winding wire is on the low-voltage side, the secondary winding wire is on the high-voltage side, and the low-voltage power supply is switched to supply power to the control circuit located on the high-voltage side.

Further, as in the invention of claim 6, the switching power supply device of the invention is remarkably suitable for switching a low-voltage power supply mounted on a vehicle in an in-vehicle electric compressor including a control circuit, an inverter circuit to which power is supplied from a high-voltage power supply mounted on the vehicle and which is controlled by the control circuit, and a motor driven by the inverter circuit.

Here, as in the invention of claim 7, in the case in which an insulated wire is used as the primary winding wire and the secondary winding wire, it is possible to further reduce the parasitic capacitance between the primary winding wire and the secondary winding wire via the core by increasing the width dimension of the flange portion within the range of the width dimension of the barrier tape without using the barrier tape provided between the primary winding wire and the secondary winding wire and the flange portion of the bobbin.

Also in this case, as in the invention of claim 8, the enlarged width of the width dimension of the flange portion is equal to or substantially equal to the dimension in the direction orthogonal to the air gap layer or the middle leg portion of the shield layer, and thus, it is possible to obtain a sufficient parasitic capacitance reduction effect.

### BRIEF DESCRIPTION OF DRAWINGS

FIG. 1 is a block diagram of an electric circuit of an in-vehicle electric compressor according to an embodiment to which a switching power supply device of the present invention is applied.

FIG. 2 is a diagram showing a structure of a switching transformer of the present invention.

FIG. 3 is a cross-sectional view of a core of the switching transformer of FIG. 2.

FIG. 4 is a diagram for explaining the impedance between a primary winding wire and a secondary winding wire of the switching transformer of FIG. 2.

FIG. 5 is a view for explaining a structure of a switching transformer of the switching power supply device of FIG. 1 when an insulated wire is used as the primary winding wire and the secondary winding wire.

FIG. 6 is a view showing a grounding structure of a switching transformer of the switching power supply device in FIG. 1.

FIG. 7 is a cross-sectional view of a core of the switching transformer of FIG. 6.

FIG. 8 is a diagram for explaining a reduction effect of common mode noise by the grounding structure of FIG. 6.

FIG. 9 is a diagram for similarly explaining a reduction effect of common mode noise by the grounding structure of FIG. 6.

FIG. 10 is a diagram for explaining common mode noise in the case in which a grounding position is changed in the switching transformer of FIG. 6.

FIG. 11 is a diagram for similarly explaining common mode noise in the case in which a grounding position is changed in the switching transformer of FIG. 6.

FIG. 12 is a diagram for explaining a grounding structure of the switching transformer of FIG. 6, having different winding wire specifications.

### DESCRIPTION OF EMBODIMENTS

Note that in the following, an embodiment of the present invention will be described in detail with reference to the drawings.

### (1) In-Vehicle Electric Compressor 1

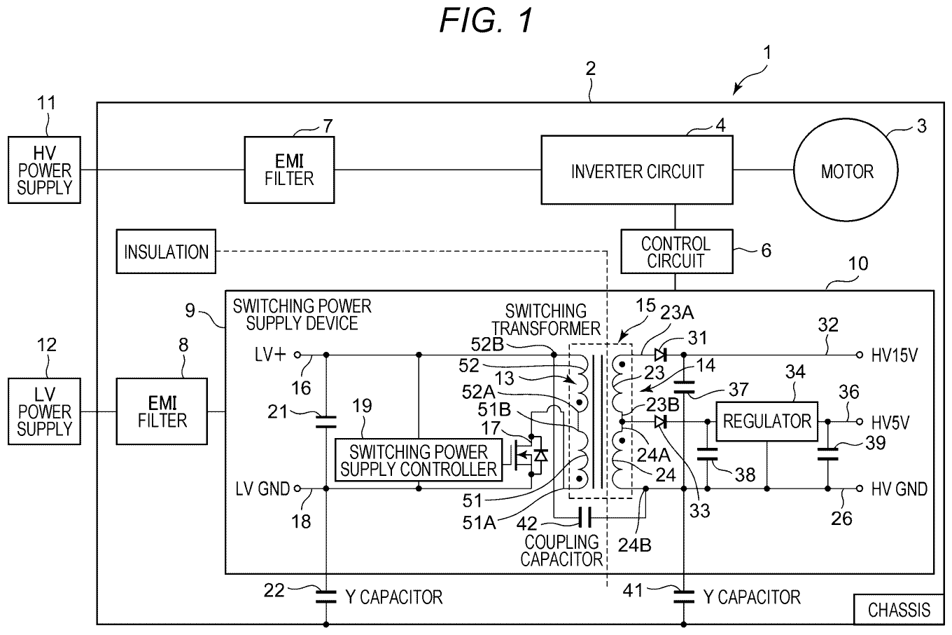

In FIG. 1, reference numeral 1 denotes an in-vehicle electric compressor that is mounted on a vehicle such as an electric vehicle or a hybrid vehicle and that constitutes a refrigerant circuit of a vehicle air conditioner that air-conditions the interior of the vehicle, and reference numeral 2 denotes a chassis (housing) of the in-vehicle electric compressor. The chassis 2 accommodates a compression mechanism (not shown), a motor 3 that drives the compression mechanism, an inverter circuit 4 that operates the motor 3, a control circuit 6 that controls the inverter circuit 4, EMI filter circuits 7 and 8, a switching power supply device 9 of the present invention, and the like.

Note that the vehicle is mounted with the motor 3 of the in-vehicle electric compressor 1, a high-voltage power supply (HV power supply) 11 including a high-voltage battery of, e.g., about a direct current of 300 V (300 V DC) for supplying power to and driving a motor for traveling (not shown), and a low-voltage power supply (LV power supply) 12 including a battery (direct current 12 V power supply) of a normal direct current of 12 V (12 V DC). The high-voltage side of the in-vehicle electric compressor 1 is connected to the high-voltage power supply 11, and the low-voltage side is connected to the low-voltage power supply 12. In addition, the chassis 2 of the in-vehicle electric compressor 1 is electrically connected to the vehicle body to be grounded.

The inverter circuit 4 includes six switching elements (not shown) including IGBTs and the like connected in a three-phase bridge, and the switching elements are controlled by a gate drive signal generated by a gate driver included in the control circuit 6. The control circuit 6 includes a microprocessor, and performs PWM modulation by switching the switching elements of the inverter circuit 4 by a gate driver to set a DC voltage of the high-voltage power supply 11 to a predetermined AC voltage and supply the AC voltage to the motor 3.

The EMI filter circuit 7 is connected across the high-voltage power supply 11 and the inverter circuit 4, and has an effect of reducing EMI noise generated by switching the inverter circuit 4. In addition, the EMI filter circuit 8 is connected across the low-voltage power supply 12 and the switching power supply device 9, and exerts an effect of reducing EMI noise generated by switching in the switching power supply device 9 as described later.

### (2) Switching Power Supply Device 9

The switching power supply device 9 is a DC-DC converter that generates a predetermined DC voltage (15V HV, 5V HV) by switching the low-voltage power supply 12 (12 V DC) to supply power to the control circuit 6. The switching power supply device 9 is formed such that electric elements described later are mounted on a substrate 10. Note that 15V HV is a voltage supplied to the gate driver (included in the control circuit 6) that generates a gate drive signal of the inverter circuit 4, and 5V HV is a voltage serving as a power source of the control circuit 6.

The switching power supply device 9 includes a switching transformer 15 constituted of an isolation transformer including a primary winding wire 13 on a low-voltage side (connected to the low-voltage power supply 12) and a secondary winding wire 14 on a high-voltage side (connected to the high-voltage power supply 11) insulated from the primary winding wire 13 in the present embodiment. In the embodiment, the primary winding wire 13 uses a magnet wire, and includes a first winding wire portion 51 (Np-1) having a winding start end 51A and a winding finish end 51B and a second winding wire portion 52 (Np-2) also having a winding start end 52A and a winding finish end 52B.

The winding finish end 52B of the second winding wire portion 52 is connected to the EMI filter circuit 8 by a primary-side power line (LV+) 16, and is further connected to the low-voltage power supply 12. In addition, the winding start end 52A of the second winding wire portion 52 is connected to the winding finish end 51B of the first winding wire portion 51, and the winding start end 51A of the first winding wire portion 51 is connected to the drain terminal of the switching element 17 including a MOSFET in the embodiment.

The source terminal of the switching element 17 is connected to the LVGND 18, which is a ground (primary-side ground) on the low-voltage side (connected to the low-voltage power supply 12), and the winding start end 51A of the first winding wire portion 51 of the switching transformer 15 is not directly connected to the LVGND 18.

Reference numeral 19 in the drawing denotes a switching power supply controller (controller), and power is supplied to the switching power supply controller 19 from the low-voltage power supply 12 via a primary-side power line 16. The output of the switching power supply controller 19 is connected to the gate of the switching element 17, and the switching of the switching element 17 is controlled by the switching power supply controller 19.

Consequently, the primary winding wire 13 of the switching transformer 15 is located on the low-voltage side (connected to the low-voltage power supply 12). Note that reference numeral 21 denotes a smoothing capacitor connected across the primary-side power line 16 and the primary-side ground 18. In addition, in the embodiment, the LVGND 18 insulated from the secondary side (HVGND 26, described later) by the switching transformer 15 is connected to the chassis 2 (ground) via a Y capacitor (line bypass capacitor) 22 that attenuates the common mode noise. Note that one end of the low-voltage power supply 12 is also connected to the chassis 2.

On the other hand, the secondary winding wire 14 of the switching transformer 15 also uses a magnet wire in this embodiment, and includes a first winding wire portion 23 (Ns-1) having a winding start end 23A and a winding finish end 23B and a second winding wire portion 24 (Ns-2) also having a winding start end 24A and a winding finish end 24B. The winding finish end 24B of the second winding wire portion 24 is connected to the HVGND 26, which is a ground (secondary-side ground) on the high-voltage side (connected to the high-voltage power supply 11).

The winding start end 23A of the first winding wire portion 23 is then connected to the 15V HV line (first high-voltage side power supply line) 32 via a diode 31, and the gate driver of the control circuit 6 described above is connected to the 15V HV line 32. The winding start end 24A of the second winding wire portion 24 is connected to a 5V HV line (second high-voltage side power line) 36 via a diode 33 and a regulator (low-dropout regulator (LDO)) 34, and the 5V HV line 36 serves as the power source of the control circuit 6.

In addition, the winding start end 24A of the second winding wire portion 24 is connected to the winding finish end 23B of the first winding wire portion 23, and the winding finish end 24B of the second winding wire portion 24 is connected to the HVGND 26 as described above.

Note that smoothing capacitors 37 to 39 are smoothing capacitors connected across the 15V HV line 32 and the HVGND 26, and across the 5V HV line 36 and the HVGND 26 subsequent to the regulator 34. In addition, in the embodiment, the HVGND 26 (secondary-side ground) isolated from the primary side (LVGND 18) by the switching transformer 15 is connected to the chassis 2 (ground) via a Y capacitor (line bypass capacitor) 41 that attenuates the common mode noise.

The switching power supply controller 19 then performs switching control on the switching element 17 such that 15 V DC (HV15 V) is output to the 15V HV line 32 in accordance with the turn ratio of the switching transformer 15. As a result, 15 V DC (HV15 V) is supplied to the gate driver of the control circuit 6, and 5V DC (5 V HV) is supplied to the control circuit 6 itself from the intermediate output according to the turn ratio of the first winding wire portion 23 and the second winding wire portion 24 via the regulator 34.

The switching power supply device 9 switches the low-voltage power supply 12 to supply power to the control circuit 6, and the switching transformer 15 provides the insulation of the low-voltage side where the primary winding wire 13 is located (connected to the low-voltage power supply 12 as described above) from the high-voltage side where the secondary winding wire 14 is located (connected to the high-voltage power supply 11 as described above) (indicated by a broken line “insulated” in the drawing). As a measure against EMI noise resulting from the switching of the switching element 17 in the switching power supply device 9, the winding finish end 52B of the second winding wire portion 52 of the switching transformer 15 and the winding finish end 24B of second winding wire portion 24 are coupled to each other via the coupling capacitor 42.

By coupling the winding finish end 52B of the second winding wire portion 52 of the switching transformer 15 to the winding finish end 24B of the second winding wire portion 24 with the coupling capacitor 42 in this manner, accordingly to the switching of the switching element 17, the noise mutually transmitting between the primary winding wire 13 and the secondary winding wire 14 via the parasitic capacitance (coupling capacitance) between the winding wires of the switching transformer 15 (between the primary winding wire 13 and the secondary winding wire 14) is caused to flow back, and the common mode noise current flowing to the chassis 2 side (ground: finally the vehicle body side) of the electric compressor 1 is suppressed. As a result, the noise voltage is reduced.

### (3) Structure of the Switching Transformer 15

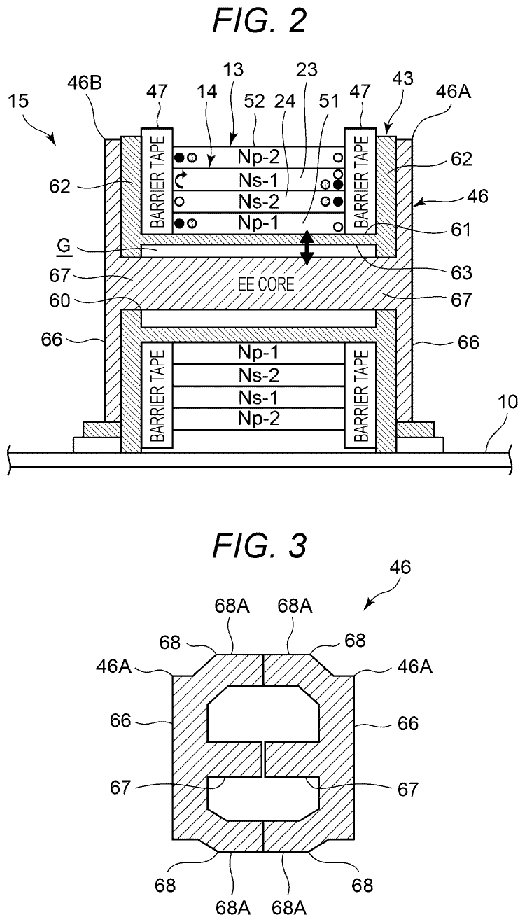

Next, the structure of the switching transformer 15 in this embodiment will be described with reference to FIGS. 2 and 3. In the drawings, reference numeral 43 denotes a bobbin around which the first winding wire portion 51 (Np-1) and the second winding wire portion 52 (Np-2) of the primary winding wire 13 and the first winding wire portion 23 (Ns-1) and the second winding wire portion 24 (Ns-2) of the secondary winding wire 14 are wound, reference numeral 46 denotes a core, and reference numeral 47 denotes a barrier tape.

The bobbin 43 is made of a hard synthetic resin, and has a winding shaft portion 61 in the center and flange portions 62 respectively formed on both sides of the winding shaft portion 61 in the axial direction, and a through hole 60 is formed in the winding shaft portion 61. The first winding wire portion 51 (Np-1) and the second winding wire portion 52 (Np-2) of the primary winding wire 13 and the first winding wire portion 23 (Ns-1) and the second winding wire portion 24 (Ns-2) of the secondary winding wire 14 are wound around the outer surface of the winding shaft portion 61 of the bobbin 43. In this embodiment, the first winding wire portion 51 (Np-1) is wound around the innermost layer, the second winding wire portion 24 (Ns-2) is wound around the outer side, the first winding wire portion 23 (Ns-1) is wound around the outer side, and the second winding wire portion 52 (Np-2) is wound around the outermost layer.

That is, the structure is provided in which the first winding wire portion 23 (Np-1) and the second winding wire portion 24 (Np-2) of the primary winding wire 13 are sandwiched between the first winding wire portion 51 (Ns-1) and the second winding wire portion 52 (Ns-2) of the secondary winding wire 14, and this maintains the magnetic coupling of the primary winding wire 13 to the secondary winding wire 14. In addition, in this embodiment, a recess 63 is formed on the inner surface of the through hole 60 of the winding shaft portion 61 of the bobbin 43.

The barrier tape 47 is wound around the winding shaft portion 61 between the first and second winding wires 13 and 14 and the flange portion 62 of the bobbin 43.

In this case, the barrier tape 47 is necessary because the first and second winding wires 13 and 14 are magnet wires as described above, and the barrier tape 47 is wound around the winding shaft portion 61 with a width satisfying the safety standard requirement.

On the other hand, the core 46 is formed of a pair of core materials 46A and 46B made of ferrite (Mn—Zn). The core materials 46A and 46B have a line-symmetric shape, and are arranged to face each other as shown in FIG. 3 to form the core 46. The core materials 46A and 46B include a base 66, a middle leg portion 67 protruding from the center of the base 66, and an outer leg portion 68 protruding from the outer end of the base 66.

The middle leg portions 67 of the core materials 46A and 46B are then inserted from both sides into the through holes 60 of the winding shaft portion 61 of the bobbin 43 around which the primary and secondary winding wires 13 and 14 and the barrier tape 47 are wound. In this state, the base portion 66 of the core materials 46A and 46B corresponds to the outer side of the flange portion 62 of the bobbin 43. In addition, the outer leg portion 68 covers the outer side of the second winding wire portion 52, which is the outermost layer in the embodiment. Further, the outer leg portion 68 is formed with an overhanging portion 68A projecting in a direction (outward) away from the middle leg portion 67.

Note that FIG. 3 shows a cross section of the core 46 cut in the horizontal direction in FIG. 2. In addition, in FIG. 2, a black circle indicates the winding start end of each winding wire described above, and a white circle indicates the winding finish end. In addition, hatched circles indicate hot ends vibrating at high frequencies. Further, the lower side (substrate 10 side) from the middle leg portion 67 in FIG. 2 is symmetrical with the upper side, and thus no reference sign is denoted.

In this embodiment, since the recess 63 is formed on the inner surface of the through hole 60 of the winding shaft portion 61 of the bobbin 43 as described above, the air gap layer (indicated by G in FIG. 2) is formed in the through hole 60 between the winding shaft portion 67 and the middle leg portion 67 in a state where the middle leg portion 67 of the core 46 is inserted. In addition, as described above, the overhanging portion 68A is formed on the outer leg portion 68. The overhanging portion 68A is formed corresponding to the second winding wire portion 52 of the outermost layer, and an interval of a predetermined dimension is formed between the second winding wire portion 52 and the inner surface of the overhanging portion 68A.

Note that in the present embodiment, the dimension of the interval between the second winding wire portion 52 and the inner surface of the overhanging portion 68A is set to the same as or substantially the same as the dimension in the direction orthogonal to the middle leg portion 67 of the air gap layer G.

As described above, since the air gap layer G is formed between the winding shaft portion 61 of the bobbin 43 of the switching transformer 15 and the middle leg portion 67 of the core 46, the distance between the innermost first winding wire portion 51 closest to the core 46 and the middle leg portion 67 of the core 46 can be secured by the air gap layer G, and the coupling between the primary winding wire 13 and the secondary winding wire 14 via the core 46 can be improved.

That is, the parasitic capacitance between the primary winding wire 13 and the secondary winding wire 14 via the core 46 is reduced. Consequently, it is possible to reduce the amount of noise converted into the common mode while maintaining the magnetic coupling between the primary winding wire 13 and the secondary winding wire 14. At this time, although there is a concern about an increase in leakage magnetic flux by providing the air gap layer G, the relative permeability of the core 46 is sufficiently large, and the influence of the increase in leakage magnetic flux is limited due to the structure of the switching transformer 15.

In addition, in the embodiment, since the overhanging portion 68A overhanging in the direction away from the middle leg portion 67 is provided in the outer leg portion 68 of the core 46 that covers the outer side of the bobbin 43, it is possible to avoid the disadvantage that the distance between the second winding wire portion 52 of the outermost layer and the outer leg portion 68 of the core 46 is short by providing the air gap layer G between the winding shaft portion 61 and the middle leg portion 67. As a result, it is also possible to eliminate an increase in the parasitic capacitance between the primary winding wire 13 and the secondary winding wire 14 via the outer leg portion 68 of the core 46.

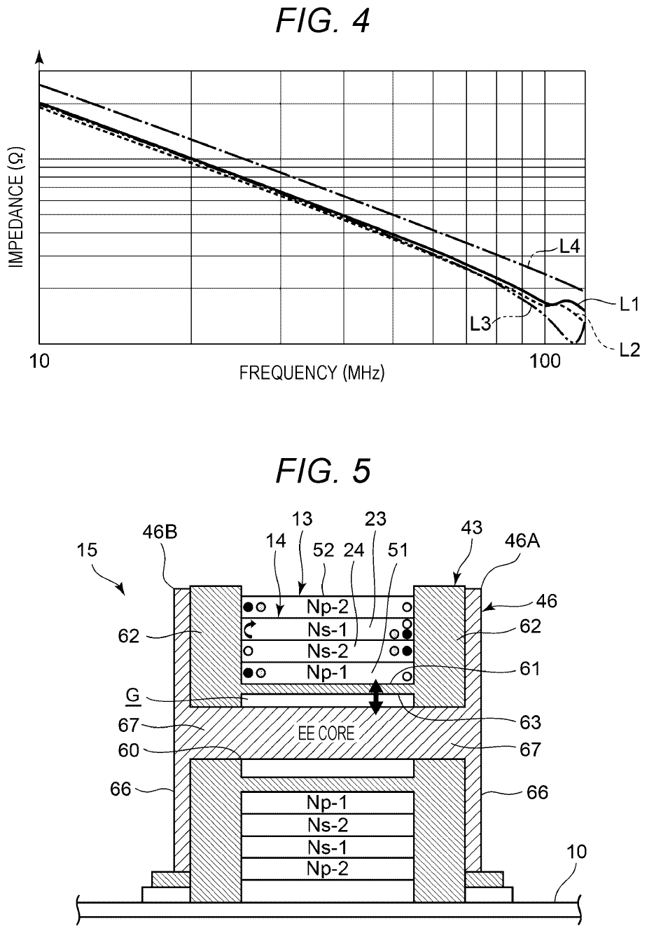

FIG. 4 shows the frequency characteristics of impedance between the primary winding wire and the secondary winding wire of the switching transformer. Note that in this drawing, L1 represents the switching transformer 15 of the embodiment of FIG. 2, L2 represents the case in which the dimension of the air gap layer G in the direction orthogonal to the middle leg portion 67 is doubled as compared with the case of FIG. 2, L3 represents the case in which the air gap layer G is not provided, and L4 represents the case in which the primary winding wire and the secondary winding wire are separated as in Patent Literature 2 described above.

In the case of LA, since the magnetic coupling of the primary winding wire to the secondary winding wire is reduced, the impedance is high in the entire frequency band. In the case of L3, the impedance sharply decreases in the FM band. At L2, the distance between the winding wire of the outermost layer and the outer leg portion of the core becomes short, and the impedance decreases in the FM band.

On the other hand, in L1 in the case of the switching transformer 15 in FIGS. 2 and 3, the impedance is low in the frequency band lower than the FM band, similarly to L3, and the impedance can be made higher in the FM band than in the case of L2 or L3. Therefore, this shows that the amount of noise converted into the common mode can be reduced.

Note that in the embodiment, the recess 63 is formed on the inner surface of the winding shaft portion 61 of the bobbin 43 to form the air gap layer G, and the air gap layer G can be easily formed. In this case, the recess 63 may be formed on the middle leg portion 67 side of the core 46. In addition, a shield layer may be formed there using the air gap layer G formed of the recess 63. The shield layer is made of a low dielectric constant material.

In addition, in the embodiment, the dimension between the inner surface of the overhanging portion 68A and the second winding wire portion 52 of the outermost layer is the same as or substantially the same as the dimension in the direction orthogonal to the middle leg portion 67 of the air gap layer G, and thus, it is possible to stop unnecessary expansion of the external dimension of the switching transformer 15.

As in the embodiment, the switching power supply device 15 is extremely suitable for switching the low-voltage power supply 12 mounted on the vehicle in the in-vehicle electric compressor 1 including the control circuit 6, the inverter circuit 4 to which power is supplied from the high-voltage power supply 11 and controlled by the control circuit 6, and the motor 3 driven by the inverter circuit 4.

### (4) Other Structures of the Switching Transformers 15

Next, FIG. 5 shows the structure of the switching transformer 15 when an insulated wire is used as the primary winding wire 13 and the secondary winding wire 14. Note that, in this drawing, components denoted by the same reference numerals as those in FIG. 2 have the same or similar functions.

The primary winding wire 13 and the secondary winding wire 14 of this embodiment use a reinforced insulation wire having a plurality of layers of insulation coating. Unlike a normal magnet wire (enameled wire), the reinforced insulation wire has high insulation performance, and thus, a barrier tape is unnecessary according to safety standards.

Therefore, in this embodiment, the barrier tape 47 used in the above-described embodiment is not used. Instead, the width dimension of the flange portion 62 of the bobbin 43 is enlarged within the range of the width dimension of the barrier tape 47.

As a result, the parasitic capacitance between the primary winding wire 13 and the secondary winding wire 14 via the core 62 can be further reduced.

Note that when the width dimension of the flange portion 62 of the bobbin 43 is enlarged, the enlarged width may be the same as or substantially the same as the dimension in the direction orthogonal to the middle leg portion 67 of the air gap layer G. This enables the achievement of a sufficient parasitic capacitance reduction effect.

### (5) Ground of the Switching Transformer 15

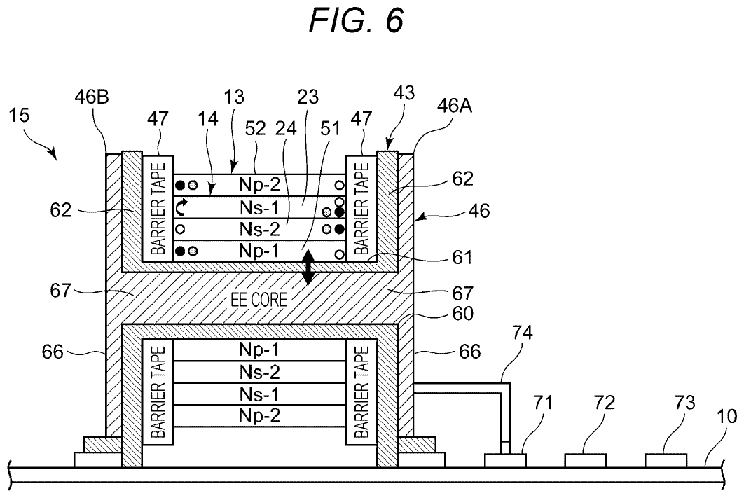

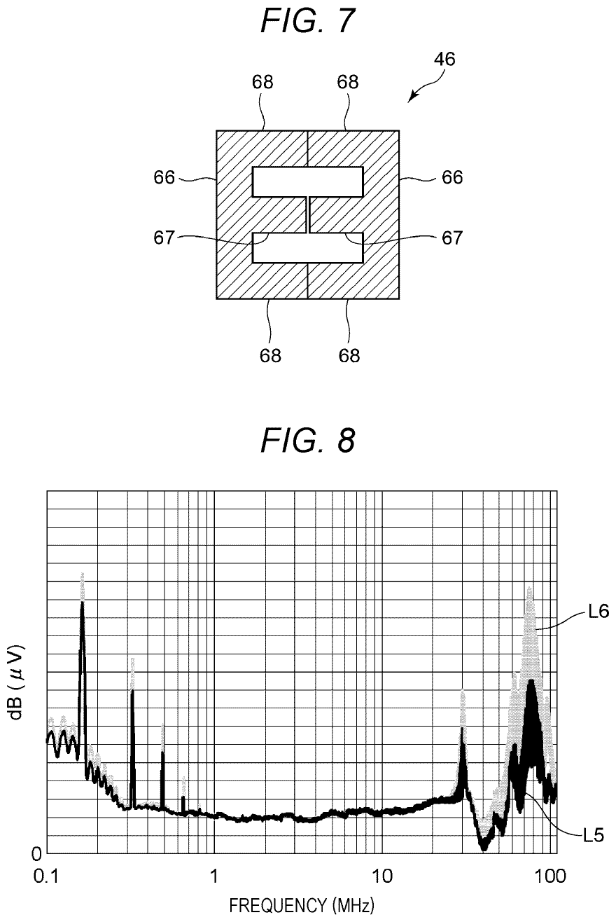

Next, a grounding structure and a method of the switching transformer 15 in FIG. 1 will be described with reference to FIGS. 6 to 12. Note that, in the drawings, those denoted by the same reference numerals as those in FIGS. 1 to 5 exert the same or similar effects, and the switching transformer 15 in this case is also wired and connected in the same manner as in FIG. 1, and thus the description of FIG. 1 is omitted.

That is, also in FIG. 6, the switching transformer 15 is an isolation transformer including the primary winding wire 13 on the low-voltage side connected to the low-voltage power supply 12 and the secondary winding wire 14 on the high-voltage side (connected to the high-voltage power supply 11 as described above) isolated from the primary winding wire 13 in the embodiment. In the embodiment, the primary winding wire 13 uses a magnet wire, and includes a first winding wire portion 51 (Np-1) having a winding start end 51A and a winding finish end 51B and a second winding wire portion 52 (Np-2) also having a winding start end 52A and a winding finish end 52B.

In FIG. 6, reference numeral 43 denotes a bobbin around which the first winding wire portion 51 (Np-1) and the second winding wire portion 52 (Np-2) of the primary winding wire 13 and the first winding wire portion 23 (Ns-1) and the second winding wire portion 24 (Ns-2) of the secondary winding wire 14 are wound, reference numeral 46 denotes a core, and reference numeral 47 denotes a barrier tape.

The bobbin 43 is made of a hard synthetic resin, and includes a winding shaft portion 61 with a hollow inside at the center and flange portions 62 formed on both sides of the winding shaft portion 61 in the axial direction. The first winding wire portion 51 (Np-1) and the second winding wire portion 52 (Np-2) of the primary winding wire 13 and the first winding wire portion 23 (Ns-1) and the second winding wire portion 24 (Ns-2) of the secondary winding wire 14 are wound around the outer surface of the winding shaft portion 61 of the bobbin 43. In the case of FIG. 6, the first winding wire portion 51 (Np-1) is wound around the innermost layer, the second winding wire portion 24 (Ns-2) is wound around the outer side, the first winding wire portion 23 (Ns-1) is wound around the outer side, and the second winding wire portion 52 (Np-2) is wound around the outermost layer.

That is, in the winding wire specification of FIG. 6, the first winding wire portion 51 (Ns-1) and the second winding wire portion 52 (Ns-2) of the secondary winding wire 14 are sandwiched between the first winding wire portion 23 (Np-1) and the second winding wire portion 24 (Np-2) of the primary winding wire 13, and thus, the magnetic coupling of the primary winding wire 13 to the secondary winding wire 14 is maintained.

The barrier tape 47 is wound around the winding shaft portion 61 between the first and second winding wires 13 and 14 and the flange portion 62 of the bobbin 43.

In this case, the barrier tape 47 is necessary because the first and second winding wires 13 and 14 are magnet wires as described above, and the barrier tape 47 is wound around the winding shaft portion 61 with a width satisfying the safety standard requirement.

On the other hand, the core 46 is formed of a pair of core materials 46A and 46B made of ferrite (Mn—Zn). The core materials 46A and 46B have a line-symmetric shape, and are arranged to face each other to form the core 46. The core materials 46A and 46B include a base 66, a middle leg portion 67 protruding from the center of the base 66, and an outer leg portion 68 protruding from the outer end of the base 66.

The middle leg portions 67 of the core materials 46A and 46B are then inserted from both sides into the winding shaft portion 61 of the bobbin 43 around which the primary and secondary winding wires 13 and 14 and the barrier tape 47 are wound. In this state, the base portion 66 of the core materials 46A and 46B corresponds to the outer side of the flange portion 62 of the bobbin 43. In addition, the outer leg portion 68 described above covers the outer side of the second winding wire portion 52, which is the outermost layer. Further, the first winding wire portion 51 (Np-1) is close to the middle leg portion part 67 of the core 46, and the second winding wire portion 52 (Np-2) is close to the outer leg portion 68.

Note that in FIG. 6, a black circle indicates the winding start end of the winding wires described above, and a white circle indicates the winding finish end. In addition, hatched circles indicate hot ends vibrating at high frequencies. Further, the lower side (substrate 10 side) from the middle leg portion 67 in FIG. 6 is symmetrical with the upper side, and thus is not denoted by a reference sign.

On the substrate 10 on the surface on which the switching transformer 15 is provided, an LVGND connection portion (land) 71, an HVGND connection portion (land) 72, and a ground connection portion (land) 73 are separately formed, the LVGND connection portion 71 is electrically connected to the LVGND 18 described above in FIG. 1, the HVGND connection portion 72 is electrically connected to the HVGND 26, and the ground connection portion 73 is electrically connected to the ground (chassis 2).

On the other hand, the switching transformer 15 is provided with a ground terminal 74, and one end of the ground terminal 74 is attached to the core 46 in a conductive manner. The other end of the ground terminal 74 of the switching transformer 15 is formed to be selectively connectable to any one of the LVGND connection portion 71, the HVGND connection portion 72, or the ground connection portion 73 described above.

### (5-1) Grounding Structure 1 of the Switching Transformer 15

Although it is known that EMI noise can be improved by grounding the core 46, in the case in which the switching transformer 15 in the winding wire specification in FIG. 6, i.e., the first winding wire portion 51 of the primary winding wire 13 on the low-voltage side is located in the innermost layer and the second winding wire portion 52 is located in the outermost layer, the other end of the ground terminal 74 is connected to the LVGND connection portion 71 as shown in FIG. 6. Accordingly, the core 46 of the switching transformer 15 is grounded to the LVGND 18.

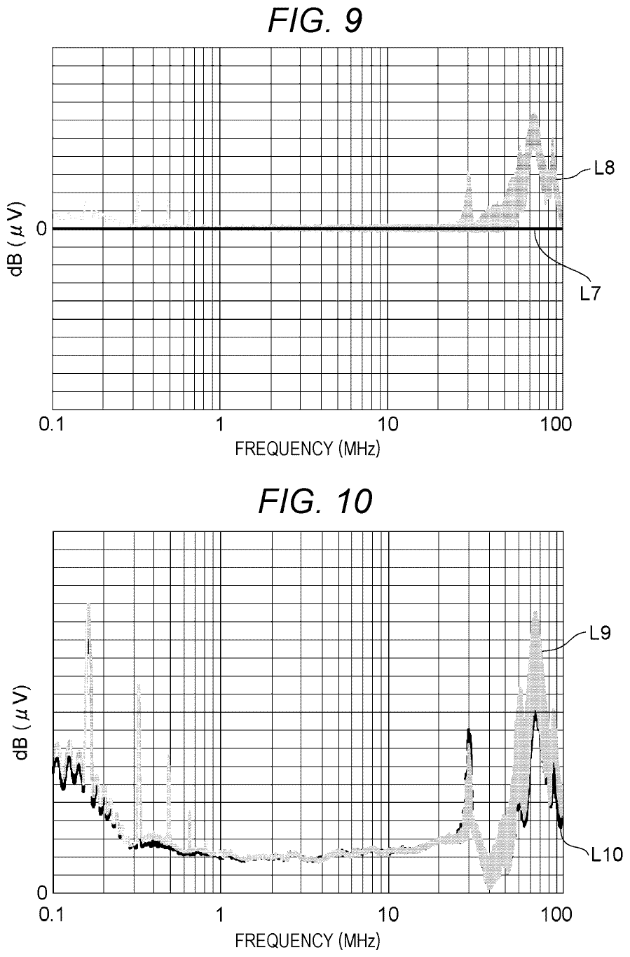

FIG. 8 shows a measurement result of the common-mode noise. In FIG. 8, L6 indicates the case in which the core 46 of the switching transformer 15 in the winding wire specification of FIG. 6 is not grounded, and L5 indicates the case in which the ground terminal 74 is connected to the LVGND connection portion 71 and the core 46 is grounded to the LVGND 18 as shown in FIG. 6. In addition, FIG. 9 shows the difference between L5 and L6 in FIG. 8, in which L7 represents L5 and L8 represents a difference based on L7.

Note that as indicated by L6 in FIG. 8, the switching power supply device 9 according to the embodiment includes a large amount of common mode noise in a high-frequency band on the low-voltage side (connected to the low-voltage power supply 12). However, by grounding the core 46 of the switching transformer 15 to the LVGND 18 as shown in FIG. 6, the core 46 has the same potential as the low-voltage side (connected to the low-voltage power supply 12), and thus, an unnecessary reflux is suppressed. As indicated by L5 in FIG. 8, high-frequency noise (VHF band) on the low-voltage side is significantly improved by suppressing unnecessary coupling. This is also apparent from the comparison between L7 and L8 in FIG. 9. In addition, low-frequency noise on the high-voltage side is also improved by suppressing unnecessary coupling.

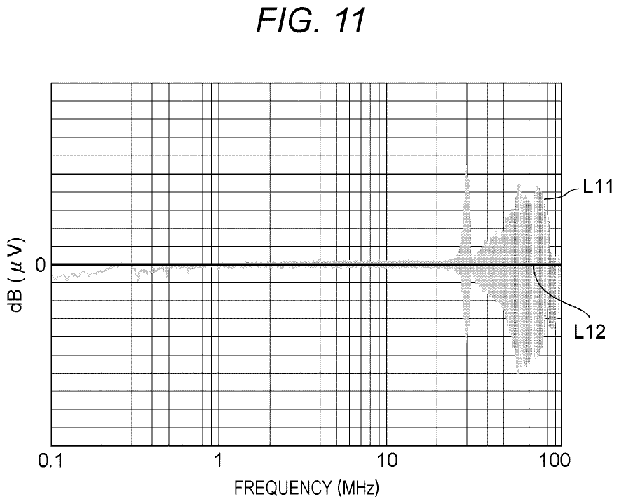

Here, FIGS. 10 and 11 show measurement results of the common mode noise in the case in which the ground terminal 74 of the switching transformer 15 in the winding wire specification of FIG. 6 is connected to the HVGND connection portion 72 and the core 46 is grounded to the HVGND 26. In FIG. 10, L10 represents the case in which the core 46 of the switching transformer 15 is not grounded, and L9 represents the case in which the ground terminal 74 is connected to the HVGND connection portion 72 and the core 46 is grounded to the HVGND 26. In addition, FIG. 11 shows a difference between L10 and L9 in FIG. 10, in which L12 represents L10, and L11 represents a difference based on L12.

In the case in which the core 46 of the switching transformer 15 in the winding wire specification of FIG. 6 is grounded to the HVGND 26, unnecessary coupling of the low-voltage side to the high-voltage side increases, and thus, high-frequency noise on the low-voltage side leaks via the high-voltage side and increases. In addition, it is shown that the low frequency noise on the high-voltage side also leaks via the low-voltage side and increases.

That is, it is shown that the core 46 has to be grounded preferentially to the LVGND 18 in the case in which the first winding wire portion 51 (Np-1) is wound on the innermost layer, the second winding wire portion 24 (Ns-2) is wound on the outer side, the first winding wire portion 23 (Ns-1) is wound on the outer side, and the second winding wire portion 52 (Np-2) is wound on the outermost layer as shown in FIG. 6.

### (5-2) Grounding Structure 2 of the Switching Transformer 15

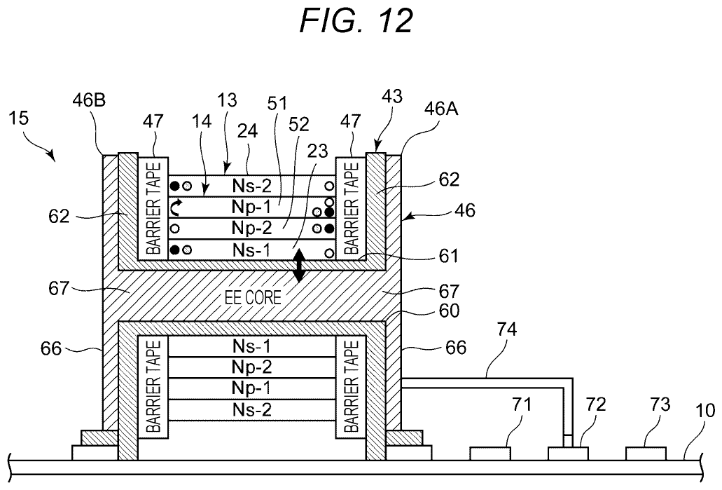

On the other hand, as shown in FIG. 12, in the case of the winding wire specification in which the first winding wire portion 23 (Ns-1) of the secondary winding wire 14 on the high-voltage side is wound on the innermost layer, the second winding wire portion 52 (Np-2) is wound on the outer side, the first winding wire portion 51 (Np-1) is wound on the outer side, and the second winding wire portion 24 (Ns-2) is wound on the outermost layer, the first winding wire portion 23 (Ns-1) comes close to the middle leg portion 67 of the core 46, and the second winding wire portion 24 (Ns-2) comes close to the outer leg portion 68. In this case, the ground terminal 74 may be connected to the HVGND connection portion 72, and the core 46 may be grounded to the HVGND 26.

When the core 46 of the switching transformer 15 in the winding wire specification of FIG. 12 is grounded to the HVGND 26, the core 46 has the same potential as that on the high-voltage side (connected to the high-voltage power supply 11), and thus, unnecessary reflux is suppressed, and the high-frequency noise on the high-voltage side is greatly improved by suppressing unnecessary coupling. In addition, low-frequency noise on the low-voltage side is also improved by suppressing unnecessary coupling.

Note that depending on the winding wire specifications of the switching transformer 15 and the frequency band range in which noise reduction is necessary, it is also conceivable to connect the ground terminal 74 to the grounding connection portion 73 and ground the core 46 to the ground (chassis 2). That is, a preferential grounding destination may be determined in advance according to the winding wire specifications of the primary winding wire 13 and the secondary winding wire 14 of the switching transformer 15 and a noise component, and the ground terminal 74 may be connected to any one of the LVGND connection portion 71, the HVGND connection portion 72, and the ground connection portion 73 at the time of assembly.

As described above, the LVGND connection portion 71, the HVGND connection portion 72, and the ground connection portion 73 electrically connected to the LVGND 18 on the low-voltage side, the HVGND 26 on the high-voltage side, and the ground (chassis 2) are formed on the substrate 10, and the ground terminal 74 of the core 46 is selectively connectable to any one of the LVGND connection portion 71, the HVGND connection portion 72, and the ground connection portion 73. Therefore, this enables the core 46 to be electrically connected to any one of the LVGND 18, the HVGND 26, and the ground (chassis 2) according to the winding wire specifications of the primary winding wire 13 and the secondary winding wire 14 and the frequency band in which noise reduction is necessary.

This enables a more effective, easily reduction in the common mode noise.

At this time, in the primary winding wire 13 and the secondary winding wire 14 wound around the bobbin 43, in the case of the winding wire specification in which the primary winding wire 13 is located at the innermost layer as shown in FIG. 6, the ground terminal 74 is connected to the LVGND connection portion 71, and thus, this enables obtaining the suppression of unnecessary reflux, and a remarkable noise improvement effect on the low-voltage side.

On the other hand, in the primary winding wire 13 and the secondary winding wire 14 wound around the bobbin 43, in the case of the winding wire specification in which the secondary winding wire 14 is located at the innermost layer as shown in FIG. 12, the ground terminal 74 is connected to the HVGND connection portion 72, and thus, this enables the suppression of unnecessary reflux, and obtaining a remarkable noise improvement effect on the high-voltage side.

Further, as shown in FIG. 6, in the case of the winding wire specification in which the first winding wire portion 51 is located in the innermost layer, the second winding wire portion 52 is located in the outermost layer, and the primary winding wire 13 is close to the middle leg portion 67 and the outer leg portion 68 of the core 46, the ground terminal 74 is connected to the LVGND connection portion 71 for LVGND, and thus, this enables the suppression of unnecessary reflux, and obtaining a remarkable noise improvement effect on the low-voltage side.

On the other hand, in the case of the winding wire specification in which the first winding wire portion 23 is located in the innermost layer, the second winding wire portion 24 is located in the outermost layer, and the secondary winding wire 14 is close to the middle leg portion part 67 and the outer leg portion 68 of the core 46 as shown in FIG. 12, the ground terminal 74 is connected to the HVGND connection portion 72, and thus, this enables the suppression of unnecessary reflux, and obtaining a remarkable noise improvement effect on the high-voltage side.

Note that the winding wire specifications of the switching transformer 15 are not limited to the above, and the present invention is also effective for different winding wire specifications. In addition, in the embodiment, the case has been described in which the high-voltage power supply 11 and the low-voltage power supply 12 are mounted on the vehicle, the primary winding wire 13(First winding wire portion 51, second winding wire portion 52) of the switching transformer 15 is on the low-voltage side, and the secondary winding wire 14(First winding wire portion 23, second winding wire portion 24) is on the high-voltage side. However, the present invention is not limited to this case, and the present invention is also effective for a device in which only the high-voltage power supply 11 is mounted and the switching transformer 15 generates a low voltage to be supplied from the high-voltage power supply 11 to the control circuit 6.

In this case, contrary to the above embodiment, the primary winding wire 13 including the first winding wire portion 51 and the second winding wire portion 52 is on the high-voltage side, and the secondary winding wire 14 including the first winding wire portion 23 and the second winding wire portion 24 is on the low-voltage side. Therefore, for example, in the case of a winding wire specification in which the first winding wire portion 51 is the innermost layer and the second winding wire portion 52 is the outermost layer, the ground terminal 74 is connected to the HVGND connection portion 72, and in the case of a winding wire specification in which the first winding wire portion 23 is the innermost layer and the second winding wire portion 24 is the outermost layer, the ground terminal 74 is connected to the LVGND connection portion 71.

Further, in the embodiment, the switching power supply device 9 of the in-vehicle electric compressor 1 is described as an example, but the present invention is effective for various switching power supply devices having a switching transformer.

### LIST OF REFERENCE SIGNS

1 In-vehicle electric compressor
2 Chassis (ground)
3 Motor
4 Inverter circuit
6 Control Circuit
7,8 EMI filter circuit
9 Switching power supply device
10 Substrate
11 High-voltage power supply
12 Low-voltage power supply
13 Primary winding wire
14 Secondary winding wire
15 Switching transformer
17 Switching element
18 LVGND
19 Switching power supply controller (controller)
23 First winding wire portion (secondary winding wire)
24 Second winding wire portion (secondary winding wire)
26 HVGND
43 Bobbin
46 Core
51 First winding wire portion (primary winding wire)
52 Second winding wire portion (primary winding wire)
60 Through hole
61 Winding shaft portion
62 Flange portion
63 Recess
67 Middle leg portion
68 Outer leg portion
68A Overhanging portion
71 LVGND connection portion
72 HVGND connection portion
73 Ground connection portion
G Air gap layer

1. A switching transformer that includes a primary winding wire and a secondary winding wire and insulates a low-voltage side from a high-voltage side, the switching transformer comprising:
a bobbin having a winding shaft portion at a center around which the primary winding wire and the secondary winding wire are wound and flange portions respectively formed on both sides of the winding shaft portion in an axial direction; and
a core having a middle leg portion that is inserted into a through hole of the winding shaft portion, wherein
an air gap layer or a shield layer is formed between the winding shaft portion and the middle leg portion.

2. The switching transformer according to claim 1, wherein a recess is formed on an inner surface of the winding shaft portion or an outer surface of the middle leg portion to form the air gap layer.

3. The switching transformer according to claim 1, wherein the core includes an outer leg portion that covers an outer side of the bobbin, and the outer leg portion includes an overhanging portion that overhangs in a direction away from the middle leg portion.

4. The switching transformer according to claim 3, wherein a dimension between an inner surface of the overhanging portion and the primary winding wire or the secondary winding wire of the outermost layer is equal to or substantially equal to a dimension in a direction orthogonal to the air gap layer or the middle leg portion of the shield layer.

5. The switching power supply device comprising a switching transformer according to claim 1, wherein
the low-voltage side is connected to a low-voltage power supply, the high-voltage side is connected to a high-voltage power supply, and the primary winding wire of the switching transformer is on the low-voltage side, and the secondary winding wire is on the high-voltage side, and the low-voltage power supply is switched to supply power to a control circuit located on the high-voltage side.

6. An in-vehicle electric compressor comprising: the switching power supply device according to claim 5 that switches the low-voltage power supply mounted on a vehicle; the control circuit; an inverter circuit that is supplied with power from the high-voltage power supply mounted on the vehicle and is controlled by the control circuit; and
a motor driven by the inverter circuit.

7. A method of manufacturing a switching transformer according to claim 1, wherein when an insulated wire is used as the primary winding wire and the secondary winding wire, a barrier tape provided between the primary winding wire and the secondary winding wire and a flange portion of the bobbin is not used, and a width dimension of the flange portion is increased within a range of a width dimension of the barrier tape.

8. The method of manufacturing a switching transformer according to claim 7, wherein an enlarged width of a width dimension of the flange portion is equal to or substantially equal to a dimension in a direction orthogonal to the middle leg portion of the air gap layer or the shield layer.

9. The switching power supply device comprising a switching transformer according to claim 2, wherein
the low-voltage side is connected to a low-voltage power supply, the high-voltage side is connected to a high-voltage power supply, and the primary winding wire of the switching transformer is on the low-voltage side, and the secondary winding wire is on the high-voltage side, and the low-voltage power supply is switched to supply power to a control circuit located on the high-voltage side.

10. The switching power supply device comprising a switching transformer according to claim 3, wherein
the low-voltage side is connected to a low-voltage power supply, the high-voltage side is connected to a high-voltage power supply, and the primary winding wire of the switching transformer is on the low-voltage side, and the secondary winding wire is on the high-voltage side, and the low-voltage power supply is switched to supply power to a control circuit located on the high-voltage side.

11. The switching power supply device comprising a switching transformer according to claim 4, wherein
the low-voltage side is connected to a low-voltage power supply, the high-voltage side is connected to a high-voltage power supply, and the primary winding wire of the switching transformer is on the low-voltage side, and the secondary winding wire is on the high-voltage side, and the low-voltage power supply is switched to supply power to a control circuit located on the high-voltage side.

12. A method of manufacturing a switching transformer according to claim 2, wherein when an insulated wire is used as the primary winding wire and the secondary winding wire, a barrier tape provided between the primary winding wire and the secondary winding wire and a flange portion of the bobbin is not used, and a width dimension of the flange portion is increased within a range of a width dimension of the barrier tape.

13. A method of manufacturing a switching transformer according to claim 3, wherein when an insulated wire is used as the primary winding wire and the secondary winding wire, a barrier tape provided between the primary winding wire and the secondary winding wire and a flange portion of the bobbin is not used, and a width dimension of the flange portion is increased within a range of a width dimension of the barrier tape.

14. A method of manufacturing a switching transformer according to claim 4, wherein when an insulated wire is used as the primary winding wire and the secondary winding wire, a barrier tape provided between the primary winding wire and the secondary winding wire and a flange portion of the bobbin is not used, and a width dimension of the flange portion is increased within a range of a width dimension of the barrier tape.
